(19) United States
(12) Patent Application Publication
(10) Pub. No.: US 2011/0090776 A1
(43) Pub. Date: Apr. 21, 2011

(54) OPTICAL HEAD DEVICE, OPTICAL INFORMATION PROCESSING APPARATUS, AND SIGNAL DETECTING METHOD

(76) Inventors: Masayuki ONO, Hyogo (JP); Hiroaki Yamamoto, Hyogo (JP)

(21) Appl. No.: 12/827,504

(22) Filed: Jun. 30, 2010

(30) Foreign Application Priority Data
Oct. 15, 2009 (JP) 2009-238174

(51) Int. Cl. G11B 7/00; G11B 27/36

(52) U.S. Cl. 369/53.12; 369/103; G9B/7; G9B/27.052

(57) ABSTRACT

An optical head device includes a light source configured to emit a light beam, a light collecting optical system configured to converge the light beam onto an information recording medium, a hologram element configured to diffract the light beam reflected from the information recording medium, and a photodetector having a plurality of detection regions configured to receive the light beam diffracted by the hologram element. The hologram element has a plurality of diffraction regions separated from each other by a straight line extending in a track direction of the information recording medium. At least one of the plurality of diffraction regions has a pattern which introduces coma aberration in the track direction to the diffracted light.

### CROSS-REFERENCE TO RELATED APPLICATION

This application claims priority to Japanese Patent Application No. 2009-238174 filed on Oct. 15, 2009, the disclosure of which including the specification, the drawings, and the claims is hereby incorporated by reference in its entirety.

### BACKGROUND

At present, optical disks are widely used as optical information recording media to and from which information can be recorded and reproduced.

Examples of optical disks include CD-ROMs, DVD-ROMs, DVD-Videos, and the like, which are read-only media, and CD-Rs, CD-RWs, DVD-Rs, and the like, which are recordable media. Conventionally, technologies for reproducing information from those optical information recording media have been developed, along with advances in their simplification and cost reduction.

An optical head device for reproducing information from such optical information recording media (hereinafter referred to as Conventional Technique 1) is described in, for example, Japanese Patent Laid-Open Publication No. H10-269588 (Document 1).

A configuration of Conventional Technique 1 will be described hereinafter with reference to FIG. 17 which schematically shows the configuration. In the optical head device, a semiconductor laser 130 emits laser light rays, and a collimator lens 111 causes the laser light rays which have been passed through a hologram element 120 to be parallel (a bundle of parallel rays). An objective lens 112 brings the bundle of parallel rays to a focus on an optical disk 110. After being reflected from the optical disk 110, the laser light travels through the objective lens 112 and the collimator lens 111 again, and is diffracted by the hologram element 120 to reach a photodetector 140. Note that, in FIG. 17, a radial direction of the optical disk 110 is referred to as an x-direction, a track direction of the optical disk 110 is referred to as a y-direction, and a direction perpendicular to these two directions is referred to as a z-direction.

Next, the hologram element 120 and the photodetector 140 will be described in detail with reference to FIG. 18.

The hologram element 120 has four diffraction regions 123A, 123B, 123C, and 123D which are separated from each other by a dividing line B121 substantially parallel to the track direction (y-direction) of the optical disk 110, and a dividing line B122 substantially parallel to the radial direction (x-direction) of the optical disk 110.

The photodetector 140 has a pair of rectangular photodetection regions S41 and S42, another pair of rectangular photodetection regions S43 and S44, and other rectangular regions S45 and S46. The photodetection regions S41 and S42 are separated from each other by a dividing line B141 substantially parallel to a diffraction direction (y-direction) of the hologram element 120. The photodetection regions S43 and S44 are separated from each other by a dividing line B142 substantially parallel to the diffraction direction (y-direction) of the hologram element 120.

When focus is achieved, light diffracted by the diffraction region 123A of the hologram element 120 forms a spot P101 on the dividing line B141, light diffracted by the diffraction region 123B forms a spot P102 on the dividing line B142, light diffracted by the diffraction region 123C forms a spot P103 on the photodetection region S45, and light diffracted by the diffraction region 123D forms a spot P104 on the photodetection region S46.

In this example, focus servo signal detection is performed using the knife-edge method. A focus servo signal is generated by the following calculation. Note that phase( ) represents phase comparison.

FE=(S41+S44)−(S42+S43) (1)

When tracking servo signal detection is performed by differential phase detection (DPD), a tracking servo signal is generated by the following calculation.

TE(DPD)=phase(S41+S42+S45,S43+S44+S46) (2)

When a push-pull signal is detected for generation of a tracking servo signal on disks having a continuous track, such as phase-change disks and the like, the push-pull signal is generated by the following calculation.

TE(PP)=(S41+S42+S46)−(S43+S44+S45) (3)

In expressions (1), (2), and (3), S41, S42, S43, S44, S45, and S46 each represent the intensity of a light signal which is obtained in the corresponding photodetection region of FIG. 18.

As a technique of detecting a focus servo signal which is different from Conventional Technique 1, an optical head device for recording and reproduction which employs the spot size detection (SSD) method (hereinafter referred to as Conventional Technique 2) is described in Japanese Patent Laid-Open Publication No. 2001-229573 (Document 2).

A configuration of Conventional Technique 2 will be described hereinafter. FIG. 19 schematically shows the configuration of the optical head device. In the optical head device, a semiconductor laser 130 emits laser light rays used for recording and reproduction, and a collimator lens 111 causes the laser light rays to be parallel (a bundle of parallel rays). A diffraction grating 124 diffracts the bundle of parallel rays (laser light) into one main beam and two sub-beams. Note that FIG. 19 shows only light paths, but not the individual main beam and sub-beams.

After being transmitted through a polarizing beam splitter 115, the three beams are directed toward an optical disk 110 by a mirror 119, and linear polarization is then converted into circular polarization by a quarter-wave plate 116. Moreover, the three beams are focused onto the optical disk 110 by an objective lens 112. The laser light reflected from the optical disk 110 travels through the objective lens 112, the quarter-wave plate 116, and the mirror 119 again, and is then reflected toward a photodetector 140 by the polarizing beam splitter 115. The reflected light is collected by a detection lens 113, and is then diffracted by a hologram element 120 to reach the photodetector 140.

The hologram element 120 has a disk-like shape as shown in FIG. 20. A dividing line B123 passes through a center of the hologram element 120. The dividing line B123 is substantially parallel to a track direction (y-direction) of the optical disk 110 in the bundle pattern of the beams reflected from the optical disk 110. Two diffraction regions 124A and 124B each having a grating with an arcuate pattern are formed on the opposite sides (right and left sides in FIG. 20) of the dividing line B123.

Therefore, the three beams (the main beam and the two sub-beams) each enter both the sides of the dividing line B123, resulting in formation of a total of at least twelve of ±first-order diffracted light beams.

The photodetector 140, which receives these ±first-order diffracted light beams, has a photodetection surface, such as that shown in FIG. 21. In this example, focus detection is performed by the spot size detection (SSD) method, and tracking detection is performed by the differential phase detection (DPD) method and the differential push-pull (DPP) method.

Specifically, the photodetection surface has twelve photodetection regions S14-S25, where six photodetection regions are arranged in a matrix of two columns×three rows on each of the opposite sides of a center line, and the two matrices of photodetection regions are symmetrical with respect to the center line as a symmetry axis. Each photodetection region is placed at a position where a corresponding one of the total of twelve of ±first-order diffracted light beams reaches.

The four photodetection regions S18-S21 on the middle row correspond to spots formed by the main beam SP1, in which focus detection and DPD detection are performed.

The photodetection regions S14-S17 and S22-S25 on the upper and lower rows correspond to spots formed by the two sub-beams SP2 and SP3, respectively, in which DPP detection is performed.

Each of the photodetection regions S18-S21 on the middle row is horizontally divided into four cells. Therefore, there are twenty-four individual regions on the entire photodetection surface.

Moreover, the pitch and pattern of the hologram element 120 are set so that light passing through the diffraction region 124A of the hologram element 120 enters the photodetection regions S14, S18 and S22, and S17, S21 and S25 on two outer ones of the four columns, and light passing through the diffraction region 124B enters the photodetection regions S15, S19 and S23, and S16, S20 and S24 on the two inner columns.

In this example, a focus error signal is detected by the SSD method FE(SSD), and a tracking error signal is detected by the DPD method TE(DPD) and the DPP method TE(DPP) (calculation using main push-pull TE(MPP) and sub-push-pull TE(SPP)). These calculations are represented by:

FE(SSD)=(B+C+F+G)−(A+D+E+H)

TE(DPD)=phase(A+B,E+F)+phase(C+D,G+H)

TE(MPP)=(A+B+C+D)−(E+F+G+H)

TE(SPP)=I−J

TE(DPP)=TE(MPP)−Gain(TE(SPP))

where phase( ) represents phase comparison, Gain( ) represents a predetermined coefficient, and A, B, C, D, E, F, G, H, I, and J represent the intensities of light signals detected by the photodetection surface of FIG. 21. These light signal intensities A, B, C, D, E, F, G, H, I, and J are represented by symbols of the photodetection regions of FIG. 21 as follows: A=A1+A2, B=B1+B2, C=C1+C2, D=D1+D2, E=E1+E2, F=F1+F2, G=G1+G2, H=H1+H2, I=I1+I2+I3+I4, and J=J1+J2+J3+J4.

### SUMMARY

In the optical head device for reproduction described in Conventional Technique 1, when focus is achieved, light is collected, as a spot for focus servo detection having a small spot diameter substantially close to the diffraction limit, onto a dividing line between photodetection regions of a photodetector. Therefore, if a cause for error, such as wavelength shift, assembly tolerance, or the like, occurs, light is likely to be collected onto substantially only one of the photodetection regions facing each other on the opposite sides of the dividing line. As a result, a large offset is likely to occur in a focus servo signal, which is a problem.

There are the six photodetection regions (see FIG. 18), and an amplifier circuit is required for each photodetection region. As a result, problems arise, such as a degradation in a reproduced signal due to an increase in amplifier noise, a degradation in a servo signal due to a circuit offset, and the like. Moreover, the circuit size of an integrated circuit used in the optical head device increases, resulting in an increase in cost, which is also a problem.

Although a focus servo signal is obtained based on diffracted light from substantially a half (the diffraction region 123A or 123B) of diffraction regions formed in the hologram element, it is preferable in terms of the S/N ratio that a focus servo signal be obtained based on diffracted light from all of the diffraction regions formed in the hologram element.

On the other hand, also in the optical head device for recording and reproduction described in Conventional Technique 2, the increase of the number of photodetection regions causes a problem similar to that of Conventional Technique 1. When the optical head device is used for reproduction, then even if only the photodetection regions on one side of the center line of FIG. 21 are used to detect only a DPD signal for tracking servo signal detection, and an SSD signal for focus servo signal detection, the number of required photodetection regions is eight (i.e., A1-H1).

It may be contemplated that an optical head device which has a configuration shown in FIG. 17 instead of, for example, the configuration of FIG. 19 is fabricated using the hologram pattern and photodetection pattern (FIGS. 20 and 21) of Conventional Technique 2 for the purpose of simplification of the optical system. Here, in order to obtain a good-quality RF signal, it is necessary to arrange a semiconductor laser as a light source used in the optical head device so that the wide radiation angle direction of the semiconductor laser is parallel to the track direction of an information recording medium. Therefore, even when only the photodetection regions on the left side of the center line of FIG. 21 are used, L-shaped holding means 741, such as that shown in FIG. 22, is required to arrange spots at desired positions, resulting in an increase in cost of processing the holding means, which is also a problem.

There is not a known configuration in which all diffraction regions formed in a hologram element can be used to generate a focus error signal, and high-cost holding means, such as L-shaped holding means or the like, is not required.

Moreover, when an optical information recording medium having two recording layers is used in the configuration of Conventional Technique 2, the following problem arises.

Dual-layer optical information recording media each include two recording layers arranged in the thickness direction of the medium. A first recording layer closer to the optical head device is a translucent recording layer. The optical head device records or reproduces information to or from the two layers by changing a focus between the first and second recording layers.

If such a dual-layer optical information recording medium is used in conventional optical head devices, a problem arises when a tracking signal is detected. Specifically, a sub-push-pull signal for tracking is disturbed. This is because reflected light from a recording layer on which focus is not achieved, which is out-of-focus light, overlaps the detection region of the photodetector 140.

This situation is shown in FIGS. 23 and 24. FIG. 23 shows a situation in which focus is achieved on a first information recording layer 181 of a dual-layer optical information recording medium which is farther from the optical head device. Not only a collected light beam from the first information recording layer 181 on which focus is achieved, but also out-of-focus light from the other layer, i.e., an out-of-focus layer on which focus is not achieved (a non-recording/reproduction layer, specifically a second information recording layer 182) enter the detection region of the photodetector 140. When out-of-focus light moves across the boundary between a recorded portion 182a and an unrecorded portion 182b of the second information recording layer 182, the out-of-focus light has a particularly significant influence on a tracking error signal due to an imbalance in the amount of light. In this case, of the three beams, the main beam having a larger light amount than those of the sub-beams becomes out-of-focus light having the most significant influence. Note that FIG. 23 shows that non-recording/reproduction layer stray light from the second information recording layer 182 includes recorded-portion reflected light from the recorded portion 182a and unrecorded-portion reflected light from the unrecorded portion 182b.

FIG. 24 shows a situation in which the out-of-focus light of the main beam enters and overlaps each photodetection region. The out-of-focus light of the main beam extends off the photodetection regions S18, S19, S20, and S21 which generate TE(MPP) to enter the photodetection regions S14, S15, S16, S17, S22, S23, S24, and S25 which generate TE(SPP).

The gain of a photodetection region which generates the TE(SPP) signal is typically set to be larger than the gain of a photodetection region which generates TE(MPP). Therefore, out-of-focus light has a significant influence on TE(SPP).

FIG. 25 shows a TE(SPP) signal which is generated when out-of-focus light moves across the boundary between the recorded portion 182a and the unrecorded portion 182b of the second information recording layer 182. Note that it is assumed that no AC signal is present.

As shown in FIG. 25, when out-of-focus light moves across the boundary between a recorded portion and an unrecorded portion, the TE(SPP) signal fluctuates, and therefore, a stable tracking error signal cannot be generated. This is one of the problems. Note that, conversely, when focus is achieved on the second information recording layer 182, reflected light from the first information recording layer 181 causes a similar problem.

In view of the aforementioned problems, the detailed description describes implementations of a lower-cost optical head device, optical information processing apparatus, and focus error signal detecting method which are capable of detection of focus and tracking error signals which allows more accurate and stable reproduction or recording.

A first example optical head device includes a light source configured to emit a light beam, a light collecting optical system configured to converge the light beam onto an information recording medium, a hologram element configured to diffract the light beam reflected from the information recording medium, and a photodetector having a plurality of detection regions configured to receive the light beam diffracted by the hologram element. The hologram element has a plurality of diffraction regions separated from each other by a straight line extending in a track direction of the information recording medium. At least one of the plurality of diffraction regions has a pattern which introduces coma aberration in the track direction to the diffracted light.

Note that at least one pair of detection regions of the plurality of detection regions possessed by the photodetector are preferably provided, facing each other, on opposite sides of the dividing line extending in the track direction. The diffracted light having the coma aberration is preferably incident on the dividing line. A focus error signal is obtained based on signals detected in the at least one pair of detection regions.

According to such an optical head device, because the hologram element has a pattern which introduces coma aberration to the diffracted light, a spot on the photodetector has a certain spot diameter even when focus is achieved. Therefore, even if a cause for error, such as wavelength shift, assembly tolerance, or the like, occurs, a sharp change in a photodetection signal can be reduced or prevented, whereby the offset of a focus servo signal and the like can be reduced.

Moreover, because the number of photodetection regions can be reduced, a servo signal having a lower degree of amplifier noise, circuit offset, and the like can be obtained. In addition, the circuit size of an integrated circuit used in the optical head device can be reduced, and the shape of means for holding the light source and the photodetector used in the optical head device can be simplified, resulting in a reduction in cost.

Moreover, the plurality of diffraction regions may include, in addition to the at least one diffraction region having the pattern which introduces the coma aberration, a pair of diffraction regions separated from each other by a straight line extending in a radial direction of the information recording medium. The plurality of detection regions possessed by the photodetector may include a second pair of detection regions provided, facing each other, on opposite sides of a second dividing line extending in the radial direction. Light beams diffracted by the pair of diffraction regions may enter the second pair of detection regions, respectively. A tracking error signal may be obtained based on signals detected in the at least one pair of detection regions and the second pair of detection regions.

With this configuration, a tracking error signal can be obtained using the diffraction region having the pattern which introduces coma aberration, and in addition, a pair of diffraction regions separated from each other by a straight line extending in the radial direction.

A second example optical head device includes a light source configured to emit a light beam, a light collecting optical system configured to converge the light beam onto an information recording medium, a hologram element configured to diffract the light beam reflected from the information recording medium, and a photodetector having a plurality of detection regions configured to receive the light beam diffracted by the hologram element.

The plurality of detection regions possessed by the photodetector include a first photodetection region and a second photodetection region provided, facing each other, on opposite sides of a first dividing line extending in a track direction of the information recording medium, and a third photodetection region and a fourth photodetection region provided, facing each other, on opposite sides of a second dividing line extending in the track direction. The hologram element has a first diffraction region and a second diffraction region separated from each other by a straight line extending in the track direction. The first diffraction region has a pattern which introduces coma aberration in the track direction, and generates diffracted light converging onto the first dividing line. The second diffraction region has a pattern which introduces coma aberration in the track direction, and generates diffracted light converging onto the second dividing line. A focus error signal is obtained based on a differential signal between a signal in the first detection region and a signal in the second detection region, and a differential signal between a signal in the third detection region and a signal in the fourth detection region.

The second example optical head device has advantages similar to those of the first example optical head device. Moreover, in the case of the second example optical head device, a focus servo signal can be generated based on diffracted light from all of the diffraction regions formed in the hologram element, which is preferable in terms of the S/N ratio.

A third example optical head device includes a light source configured to emit a light beam, a diffraction grating configured to generate one main beam and two sub-beams from the light beam, a light collecting optical system configured to converge the main beam and the sub-beams onto an information recording medium, a hologram element configured to diffract the main beam and the sub-beams reflected from the information recording medium, and a photodetector having a plurality of detection regions configured to receive light diffracted by the hologram element. The hologram element has a plurality of diffraction regions separated from each other by a straight line extending in a track direction of the information recording medium. At least one of the plurality of diffraction regions has a pattern which introduces coma aberration in the track direction to the diffracted light.

Note that the plurality of detection regions possessed by the photodetector preferably include a first pair of detection regions provided, facing each other, on opposite sides of a first dividing line extending in the track direction, and a second detection region and a third detection region provided in the track direction of the information recording medium relative to the first pair of detection regions. The diffracted light of the main beam having the coma aberration is preferably incident on the first dividing line of the first pair of detection regions. A focus error signal is preferably obtained based on signals detected in the first pair of detection regions. The diffracted light of the sub-beams preferably enters the second and third detection regions. A tracking error signal is preferably obtained based on signals detected in the second and third detection regions.

The third example optical head device has advantages similar to those of the first optical head device. Moreover, a main beam and sub-beams are generated from the light source, and the main beam can be used to obtain a focus error signal, and the sub-beams can be used to obtain a tracking error signal which allows reproduction and recording. Moreover, a tracking error signal which allows more accurate and stable reproduction and recording can be detected in an information recording medium having a plurality of information recording layers.

An example optical information processing apparatus is one which reproduces or records information from or to an information recording medium, and includes any example optical head device of the present disclosure.

According to the example optical information processing apparatus, a focus error signal and the like can be stably detected even when a multilayer information recording medium is employed, resulting in more stable recording and reproduction.

A first example method for detecting a focus error signal for an optical head device is provided. The optical head device includes a light source configured to emit a light beam, a light collecting optical system configured to converge the light beam onto an information recording medium, a hologram element configured to diffract the light beam reflected from the information recording medium, and a photodetector having a plurality of detection regions configured to receive the light beam diffracted by the hologram element. The hologram element has a plurality of diffraction regions separated from each other by a straight line extending in a track direction of the information recording medium. At least one of the plurality of diffraction regions has a pattern which introduces coma aberration in the track direction to the diffracted light. At least one pair of detection regions of the plurality of detection regions possessed by the photodetector are provided, facing each other, on opposite sides of a dividing line extending in the track direction. The diffracted light having the coma aberration is incident on the dividing line. The method includes the step of obtaining the focus error signal based on signals detected in the at least one pair of detection regions.

A second example method for detecting a focus error signal for an optical head device, is provided. The optical head device includes a light source configured to emit a light beam, a light collecting optical system configured to converge the light beam onto an information recording medium, a hologram element configured to diffract the light beam reflected from the information recording medium, and a photodetector having a plurality of detection regions configured to receive the light beam diffracted by the hologram element. The plurality of detection regions possessed by the photodetector include a first photodetection region and a second photodetection region provided, facing each other, on opposite sides of a first dividing line extending in a track direction of the information recording medium, and a third photodetection region and a fourth photodetection region provided, facing each other, on opposite sides of a second dividing line extending in the track direction. The hologram element has a first diffraction region and a second diffraction region separated from each other by a straight line extending in the track direction. The first diffraction region has a pattern which introduces coma aberration in the track direction, and generates diffracted light converging onto the first dividing line. The second diffraction region has a pattern which introduces coma aberration in the track direction, and generates diffracted light converging onto the second dividing line. The method includes the step of obtaining a focus error signal based on a differential signal between a signal in the first detection region and a signal in the second detection region, and a differential signal between a signal in the third detection region and a signal in the fourth detection region.

According to the example focus error signal detecting methods, as is similar to that described for the example optical head devices, because the hologram element has a pattern which introduces coma aberration, the offset of a focus servo signal due to a cause for error, such as wavelength shift, assembly tolerance, or the like, can be reduced. Moreover, similarly, a servo signal having a lower degree of amplifier noise and circuit offset can be obtained, the circuit size of an integrated circuit used in the optical head device can be reduced, and the shape of means for holding the light source and the photodetector used in the optical head device can be simplified.

According to the aforementioned example optical head devices, because the hologram element has a pattern which introduces coma aberration, the offset of a focus servo signal due to a cause for error can be reduced. Moreover, a servo signal having a lower degree of amplifier noise and circuit offset can be obtained. Moreover, the circuit size of an integrated circuit can be reduced, and the shape of means for holding the light source and the photodetector can be simplified, resulting in a reduction in cost.

In addition, a focus error signal can be generated based on diffracted light from all of the diffraction regions formed in the hologram element. Moreover, a main beam and sub-beams are generated from the light source, and the main beam can be used to obtain a focus error signal, and the sub-beams can be used to obtain a tracking error signal which allows reproduction and recording. Moreover, a tracking error signal which allows more accurate and stable reproduction and recording can be detected in an information recording medium having a plurality of information recording layers.

### BRIEF DESCRIPTION OF THE DRAWINGS

FIG. 1 is a diagram schematically showing a configuration of a main portion of an illustrative optical head device according to a first embodiment of the present disclosure.

FIG. 2 is a plan view showing a hologram element in the first embodiment of the present disclosure.

FIG. 3 is a plan view showing a photodetector in the first embodiment of the present disclosure.

FIGS. 4A-4E are diagrams showing spots on the photodetector in the first embodiment of the present disclosure.

FIG. 5 is a diagram showing a focus error signal in the first embodiment of the present disclosure.

FIG. 6 is a diagram schematically showing a configuration of a main portion of an illustrative optical head device according to a first embodiment of the present disclosure.

FIG. 7 is a plan view showing a hologram element in the second embodiment of the present disclosure.

FIG. 8 is a plan view showing a photodetector in the second embodiment of the present disclosure.

FIG. 9 is a diagram schematically showing a configuration of a main portion of an illustrative optical head device according to a third embodiment of the present disclosure.

FIG. 10 is a plan view showing a photodetector in the third embodiment of the present disclosure.

FIG. 11 is a diagram showing an optical information recording medium having two information recording layers, and light reflected from the medium.

FIG. 12 is a diagram showing stray light on the photodetector in the third embodiment of the present disclosure.

FIG. 13 is a diagram showing variations in a sub-push-pull signal in the third embodiment of the present disclosure.

FIG. 14 is a diagram schematically showing a configuration of a main portion of an illustrative optical head device according to a fourth embodiment of the present disclosure.

FIG. 15 is a plan view showing a photodetector in the fourth embodiment of the present disclosure.

FIG. 16 is a diagram showing stray light on the photodetector in the fourth embodiment of the present disclosure.

FIG. 17 is a diagram showing a configuration of an optical head device of Conventional Technique 1.

FIG. 18 is a diagram showing a hologram element and a photodetector in the optical head device of Conventional Technique 1.

FIG. 19 is a diagram showing a configuration of an optical head device of Conventional Technique 2.

FIG. 20 is a diagram showing a hologram element in the optical head device of Conventional Technique 2.

FIG. 21 is a diagram showing a photodetector in the optical head device of Conventional Technique 2.

FIG. 22 is a diagram for describing a configuration of a conventional optical head device.

FIG. 23 is a diagram showing an optical information recording medium having two information recording layers, and light reflected from the medium.

FIG. 24 is a diagram showing reflected light from an optical information recording medium having two information recording layers, and a photodetector in the optical head device of Conventional Technique 2.

FIG. 25 is a diagram showing variations in a sub-push-pull signal in a conventional optical head device.

### DETAILED DESCRIPTION

Embodiments of the present disclosure will be described hereinafter with reference to the accompanying drawings.

### First Embodiment

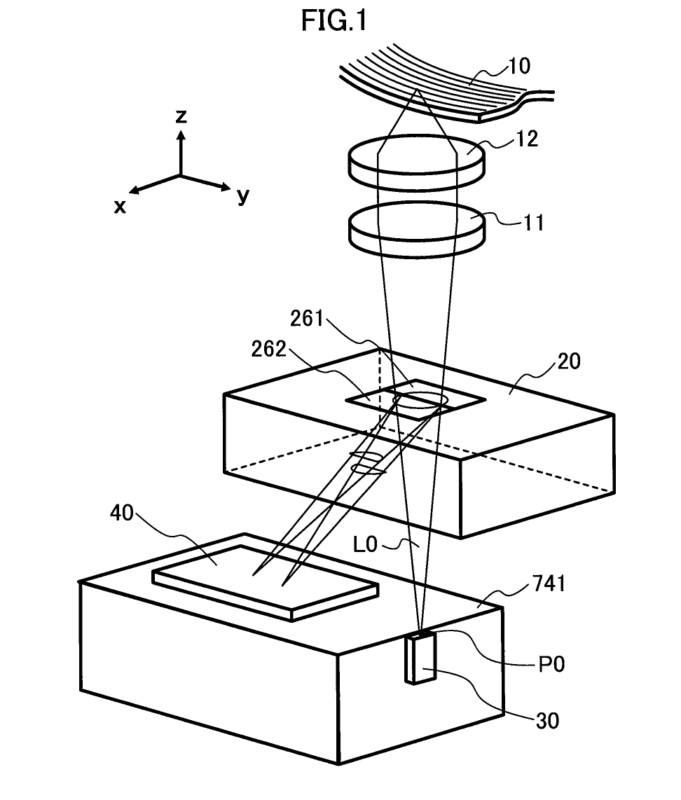

FIG. 1 is a diagram schematically showing a configuration of an illustrative optical head device according to a first embodiment of the present disclosure.

In the optical head device, a semiconductor laser 30 having an emission point P0, and a photodetector 40 are fixed to holding means 741. A hologram element 20 having a diffraction region 261 and a diffraction region 262 is also provided. The hologram element 20 is fixed to another holding means (not shown) so that the hologram element 20 has a predetermined positional relationship to the holding means 741.

Here, the holding means to which the hologram element 20 is fixed may be an optical mount for the optical head device. Alternatively, a holding member different from optical mounts may be used to provide an integral unit of the hologram element 20, the semiconductor laser 30, and the photodetector 40. With such a unit, the optical system can be more stably constructed.

The optical head device further includes a collimator lens 11 and an objective lens 12 which constitute a light collecting optical system which collects laser light (light L0) emitted by the semiconductor laser 30 onto an optical disk 10, which is an information recording medium. The optical head device further includes a lens drive mechanism (not shown) which drives and moves the objective lens 12 in an optical axis direction (Z-direction) of the objective lens 12 and in a radial direction (X-direction) of the optical disk 10.

An optical axis direction of the light collecting optical system, a radial direction of the optical disk 10, and a track direction (tangential direction) of the optical disk 10 are hereinafter referred to as a Z-direction, an X-direction, and a Y-direction, respectively, as shown in FIG. 1 unless otherwise specified. Note that, even when the optical axis is bent using a mirror, a prism, or the like in the optical system of the optical head device, the directions are defined with reference to mappings of the optical axis and the optical disk 10.

Next, laser light emitted by the semiconductor laser 30 in the optical head device of this embodiment will be described. The light L0 emitted by the semiconductor laser 30 is transmitted through the diffraction regions 261 and 262 of the hologram element 20 before being collected onto an information recording surface of the optical disk 10 by the collimator lens 11 and the objective lens 12. Light reflected from the optical disk 10 is converted, by the objective lens 12 and the collimator lens 11, into light which is in turn converged toward the emission point P0 of the semiconductor laser 30. The light thus converted enters the hologram element 20 and is diffracted by the diffraction regions 261 and 262. The diffracted light enters the photodetector 40 and is detected as a signal.

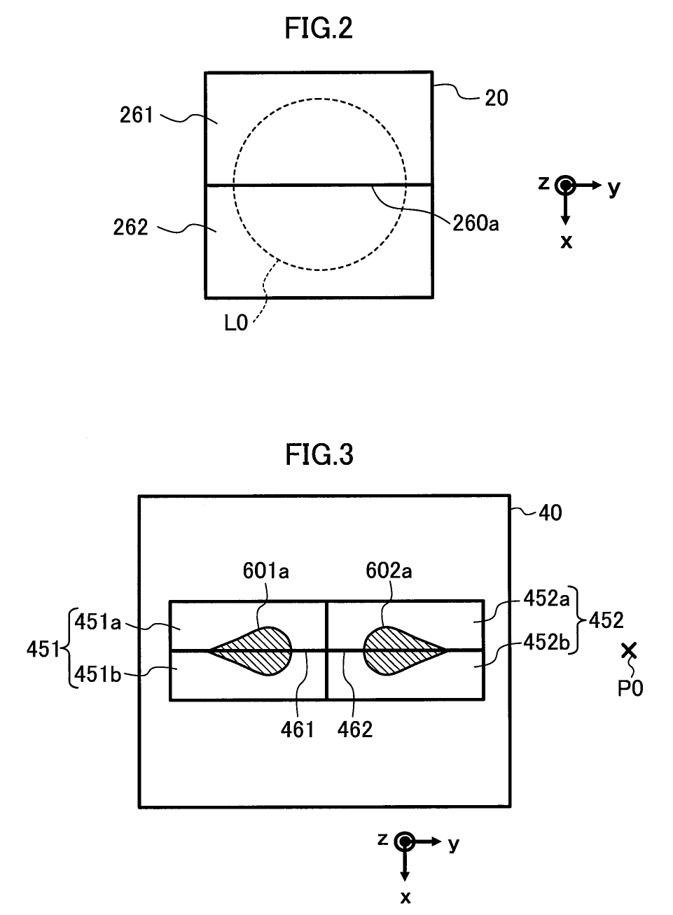

Next, the diffraction regions 261 and 262 of the hologram element 20, and the photodetector 40 will be described in detail. FIG. 2 shows the diffraction regions 261 and 262 of the hologram element 20, and FIG. 3 shows a configuration of the photodetector 40. An X-axis, a Y-axis, and a Z-axis shown in FIGS. 2 and 3 are the same as the three axes of FIG. 1.

As shown in FIG. 2, the hologram element 20 has the diffraction regions 261 and 262 which are separated from each other by a straight line 260a which is located extending through substantially a center of the light L0 (the optical axis of the light collecting optical system) and is substantially parallel to the Y-axis. The diffraction regions 261 and 262 each have a grating pattern which transmits the light emitted by the semiconductor laser 30 without modification and also diffracts returning light reflected from the optical disk 10 toward the photodetector 40. Moreover, the grating patterns of the diffraction regions 261 and 262 are different from each other, and cause diffracted light beams to enter a relatively negative side and a relatively positive side, respectively, in the Y-direction of the photodetector 40 (see FIG. 1).

On the other hand, as shown in FIG. 3, the photodetector 40 has a photodetection region group 451 and a photodetection region group 452 which are arranged side by side in the Y-direction.

The photodetection region group 451 includes a photodetection region 451a and a photodetection region 451b which are provided, facing each other, on the opposite sides of a first dividing line 461 substantially parallel to the Y-axis. The photodetection region group 452 includes a photodetection region 452a and a photodetection region 452b which are provided, facing each other, on the opposite sides of a second dividing line 462 substantially parallel to the Y-axis.

The grating pattern of the diffraction region 261 diffracts returning light from the optical disk 10 toward the photodetection region group 451 so that the diffracted light straddles the opposite sides (the photodetection regions 451a and 451b) of the first dividing line 461. Moreover, the grating pattern diffracts the returning light to form a spot 601a having coma aberration in the Y-direction which enters the photodetection region group 451.

In this case, a larger proportion of light detected by the photodetection region 451a is distributed in a more positive side of the photodetection region 451a with respect to the Y-axis of FIG. 2, and a larger proportion of light detected by the photodetection region 451b is distributed in a more negative side of the photodetection region 451b with respect to the Y-axis of FIG. 2.

Similarly, the grating pattern of the diffraction region 262 diffracts returning light from the optical disk 10 toward the photodetection region group 452 so that the diffracted light straddles the opposite sides (the photodetection regions 452a and 452b) of the second dividing line 462. Moreover, the grating pattern diffracts the returning light to form a spot 602a having coma aberration in the Y-direction which enters the photodetection region group 452, where the coma aberration has a polarity opposite to that of the diffraction region 261.

In this case, a larger proportion of light detected by the photodetection region 452a is distributed in a more positive side of the photodetection region 452a with respect to the Y-axis of FIG. 2, and a larger proportion of light detected by the photodetection region 452b is distributed in a more negative side of the photodetection region 452b with respect to the Y-axis of FIG. 2.

Therefore, the photodetection regions 451a, 451b, 452a, and 452b can be used to detect a tracking error signal using the DPD method as described below.

Moreover, because the grating patterns of the hologram element 20 have coma aberration, the spots 601a and 602a have a certain spot diameter on the photodetector 40 even when focus is achieved. Therefore, even if the spot position is shifted due to a cause for error, such as wavelength shift, assembly tolerance, or the like, a sharp change in a photodetection signal can be reduced or prevented, whereby the offset of a focus servo signal can be reduced.

Next, a method for detecting a focus error signal and a method for detecting a tracking error signal will be described. In the optical head device of this embodiment, a focus error signal FE is generated by calculation of expression (4) based on a method which is described below in detail. A tracking error signal TE_{DPD} is generated by the DPD method using calculations of the following expressions:

FE=(B+D)−(A+C) (4)

TE_{DPD}=phase(B,C)−phase(A,D) (5)

where A, B, C, and D each represent a signal detected in the corresponding photodetection region of FIG. 3. Specifically, A represents a signal detected in the photodetection region 451b, B represents a signal detected in the photodetection region 451a, C represents a signal detected in the photodetection region 452a, and D represents a signal detected in the photodetection region 452b.

Moreover, in disks, such as phase-change disks and the like, in which a continuous track is formed rather than pits and lands of DVD-ROM and the like, a tracking error signal TE_{PP} can also be detected by the push-pull method using a calculation of the following expression:

TE_{PP}=(A+B)−(C+D) (6)

A signal RF which reads information recorded on the optical disk 10 is given by:

RF=A+B+C+D (7)

As can be seen from expressions (4), (5), and (6), the number of detection regions required to detect the FE signal, the DPD signal, and the PP signal, which are required to generate a servo signal for reproduction, is four, i.e., the photodetection regions 451a, 451b, 452a, and 452b. Thus, compared to six to eight detection regions required in the conventional art, a similar function can be achieved using a smaller number of detection regions. This can reduce the number of amplifier circuits required for the detection regions (by a half in some cases), whereby the amplifier noise and the circuit offset can be reduced, resulting in a satisfactory reproduced signal and servo signal. Moreover, the circuit size of an integrated circuit used in the optical head device can be reduced, whereby the optical head device can be achieved at a lower cost.

Moreover, in order to obtain a good-quality RF signal, it is necessary to arrange a semiconductor laser as a light source used in the optical head device so that the wide radiation angle direction of the semiconductor laser is parallel to the track direction of an information recording medium. In this regard, according to this embodiment, it is no longer necessary to provide holding means having a complicated configuration, such as an L-shaped configuration or the like, as means for holding the light source (the semiconductor laser 30) and the photodetector 40, i.e., a simple shape, such as that shown in FIG. 1, may be employed, whereby the optical head device can be achieved at an even lower cost. This is achieved by combining the configuration of the hologram element 20 of FIG. 2 and the configuration of the photodetector 40 of FIG. 3.

Moreover, in the configuration of this embodiment, a focus error signal is generated based on diffracted light from all of the diffraction regions (261 and 262) formed in the hologram element 20, which is preferable in terms of the S/N ratio.

Next, a method for detecting a focus error signal in the optical head device of this embodiment will be described in detail.

Firstly, operation of detecting a focus error signal will be described.

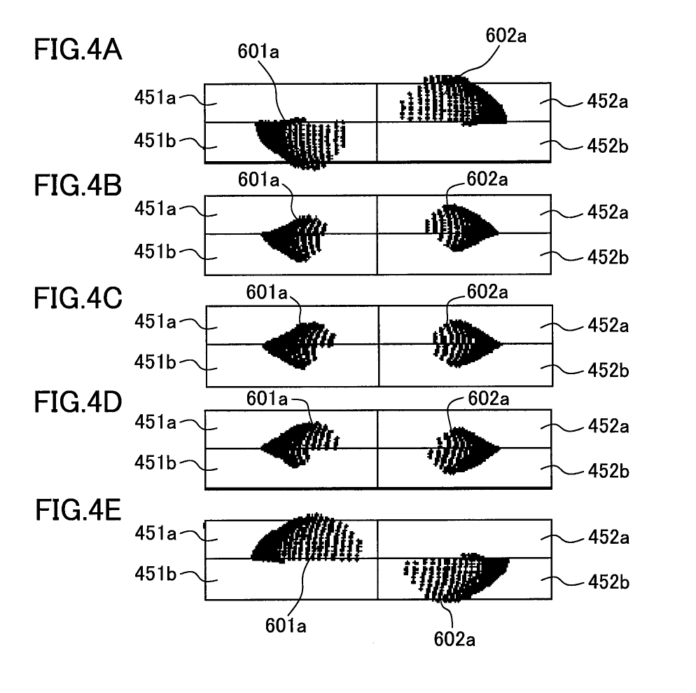

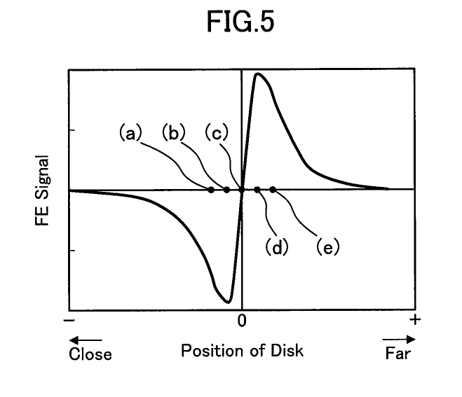

FIGS. 4A-4E show shapes of the spots 601a and 602a on the photodetector 40 which vary with the position of the optical disk 10. FIG. 5 shows a relationship between positions of the optical disk 10 and focus error signals. In FIG. 5, the origin corresponds to a state in which a minimum spot is formed on an information recording surface of the optical disk 10, i.e., an in-focus state, which is referred to as a state (c). Other states around the state (c) in which the optical disk 10 is positioned closer to or farther from the objective lens 12, are referred to as states (a)-(e) in order of closest to farthest. The states (a)-(e) correspond to the shapes of the spots 601a and 602a of FIGS. 4A-4E, respectively.

Firstly, in the case of the state (c) in which focus is achieved, the spot 601a has substantially the same distribution in the photodetection regions 451a and 451b. At the same time, the spot 602a also has substantially the same distribution in the photodetection regions 452a and 452b. Therefore, A (the signal from the photodetection region 451b) and B (the signal from the photodetection region 451a), and C (the signal from the photodetection region 452a) and D (the signal from the photodetection region 452b) are each balanced, so that the focus error signal FE represented by expression (4) is zero.

In the case of the state (b) in which the optical disk 10 is closer to the objective lens 12 than in the case of the in-focus state (c), the spot 601a is shifted so that a larger proportion thereof is distributed in the photodetection region 451b than in the photodetection region 451a, depending on how much the optical disk 10 moves closer to the objective lens 12. At the same time, the spot 602a is shifted so that a larger proportion thereof is distributed in the photodetection region 452a than in the photodetection region 452b (see FIG. 4B).

As a result, the focus error signal FE represented by expression (4) has a negative value.

In the case of the state (a) in which the optical disk 10 is even closer to the objective lens 12, as shown in FIG. 4A the entire spot 601a is shifted into the photodetection region 451a while the entire spot 602a is shifted into the photodetection region 452a. In this state, the focus error signal FE has a minimum value.

Conversely, in the state (d) in which the optical disk 10 is farther from the objective lens 12 than in the case of the state (c), the spot 601a is shifted so that a larger proportion thereof is distributed in the photodetection region 451a than in the photodetection region 451b, depending on how much the optical disk 10 moves farther away from the objective lens 12. At the same time, the spot 602a is shifted so that a larger portion thereof is distributed in the photodetection region 452b than in the photodetection region 452a (see FIG. 4D). As a result, the focus error signal FE represented by expression (1) has a positive value.

In the state (e) in which the optical disk 10 is even farther from the objective lens 12, as shown in FIG. 4E the entire spot 601a is shifted into the photodetection region 451a while the entire spot 602a is shifted into the photodetection region 452b. In this state, the focus error signal FE has a maximum value.

Thus, the focus error signal FE can be obtained as a signal which varies with the position of the optical disk 10 with respect to the objective lens 12. Here, an interval between the position of the optical disk 10 where the focus error signal FE has the maximum value and the position of the optical disk 10 where the focus error signal FE has the minimum value, i.e., a detection range of the focus error signal FE, can be set, depending on the degree of coma aberration of the hologram element 20. Note that similar advantages can be obtained for disks of different standards, such as CDs, DVDs, and BDs, by changing the semiconductor laser as the light source.

### Second Embodiment

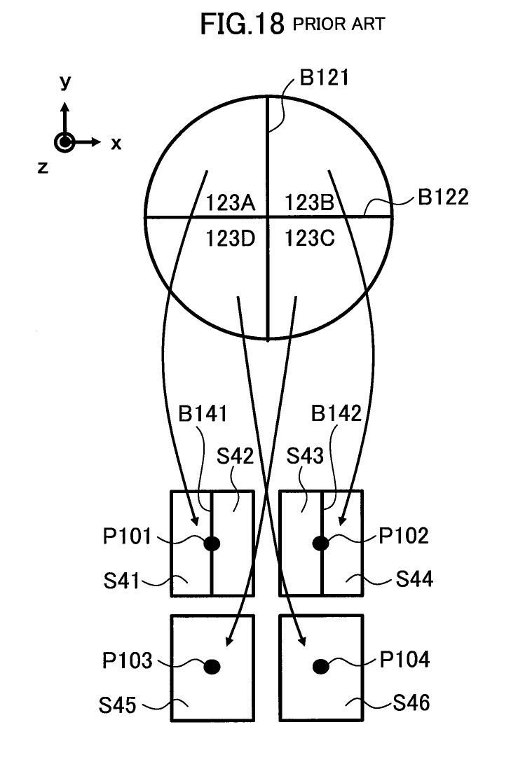

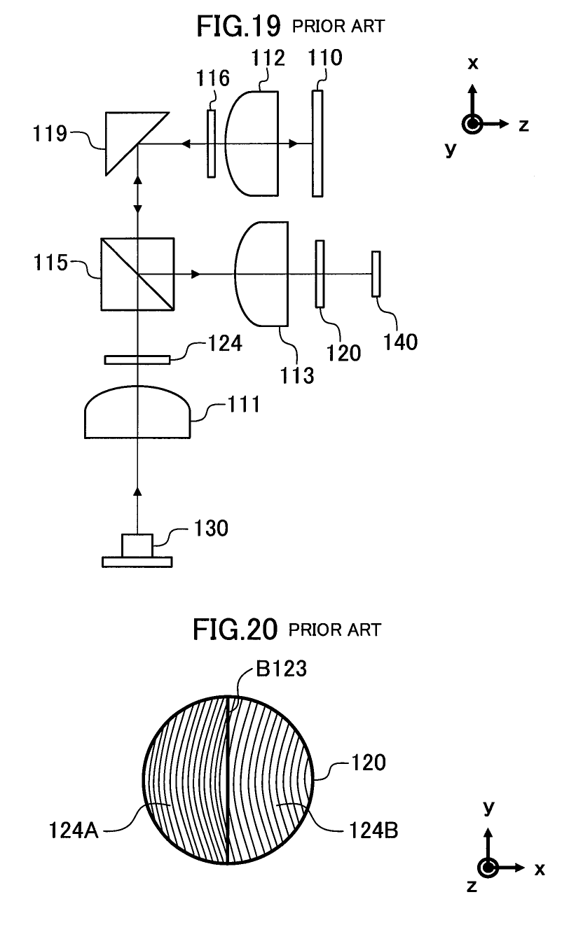

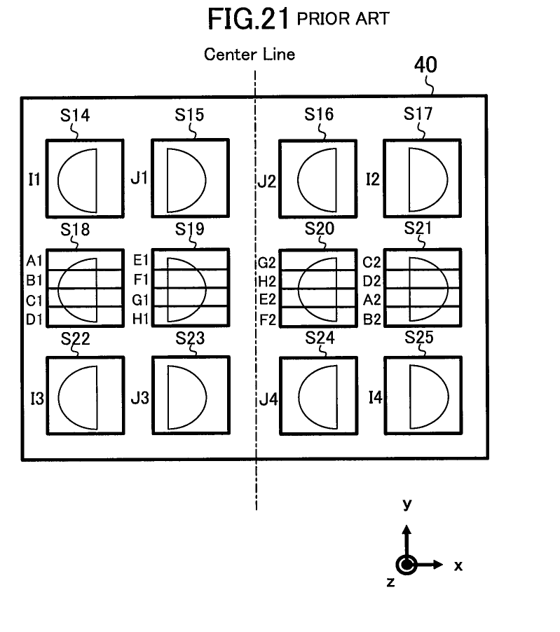

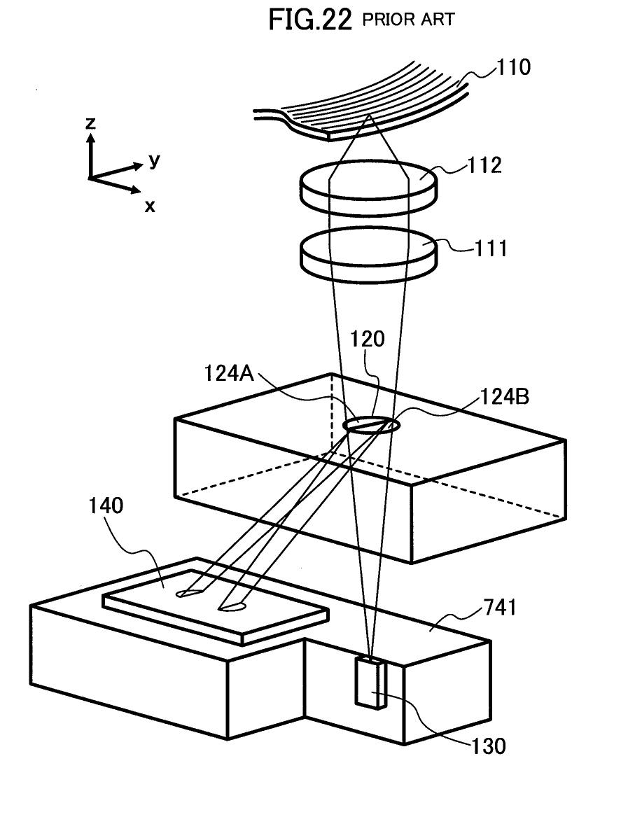

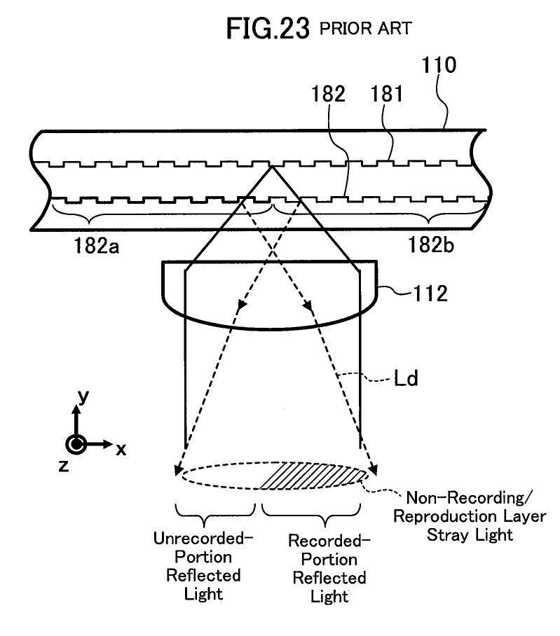

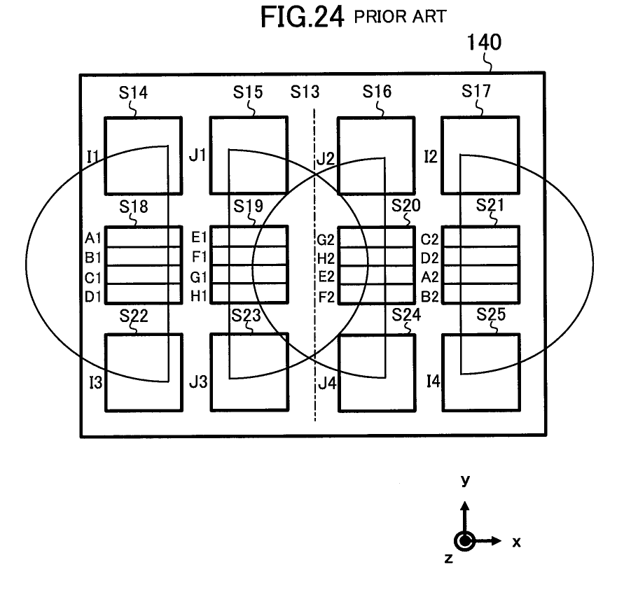

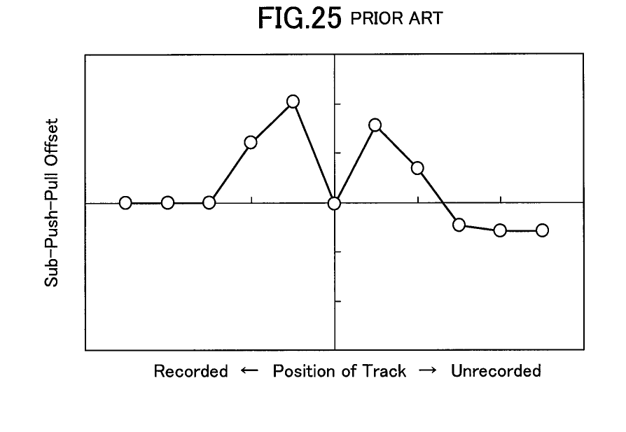

In the first embodiment, a configuration has been described in which the two diffraction regions (261 and 262 in FIG. 2) of the hologram element both have a pattern for introducing coma aberration. Alternatively, only one of the diffraction regions may have a pattern for introducing coma aberration. The offset of a focus servo signal due to a cause for error, such as wavelength shift, assembly tolerance, or the like, which occurs in the configuration of FIG. 18 described in the BACKGROUND section, can be reduced by the following embodiment in which coma aberration is introduced to diffracted light of one of the hologram patterns.

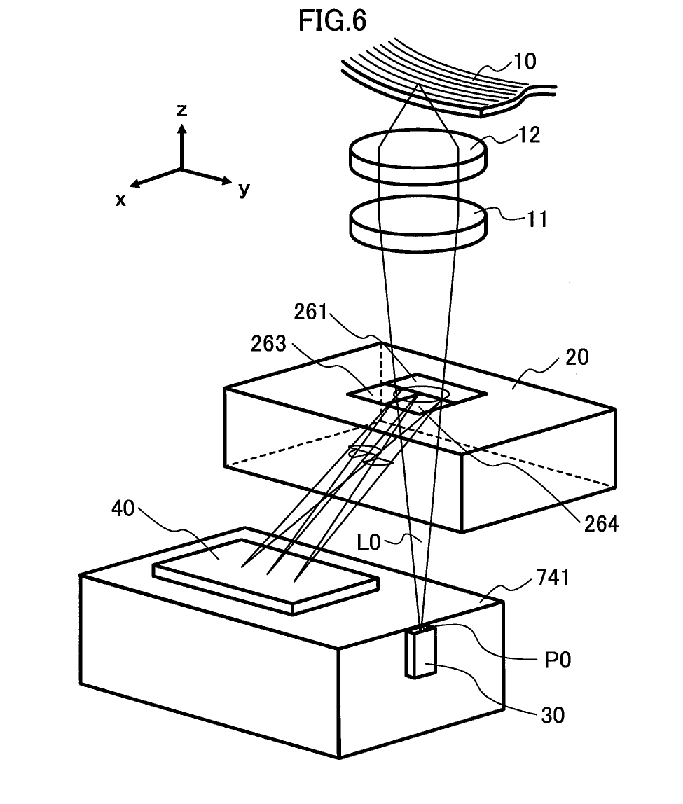

An illustrative optical head device according to a second embodiment of the present disclosure which has a configuration in which a pattern for introducing coma aberration is formed only in one of two diffraction regions of a hologram element, will be described hereinafter with reference to the drawings. FIG. 6 schematically shows a main portion of the optical head device of this embodiment.

The optical head device of FIG. 6 has a basic configuration similar to that of the optical head device of the first embodiment of FIG. 1, except that the diffraction region of a hologram element 20 is divided into three. In FIG. 6, the same components as those of FIG. 1 are indicated by the same reference characters. Different portions will be mainly described hereinafter.

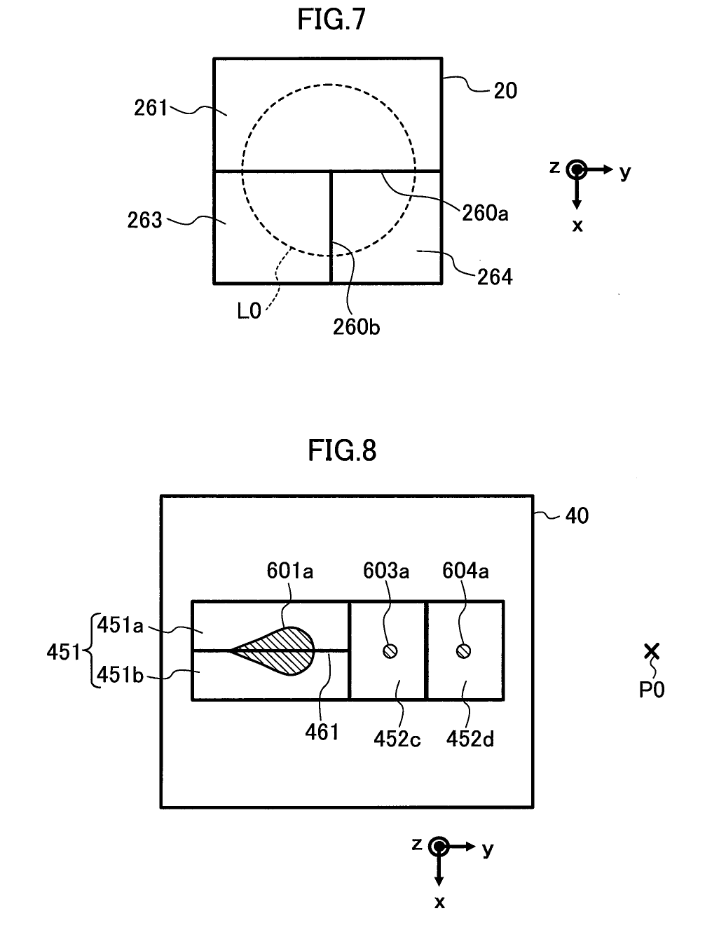

As shown in FIG. 7, the hologram element 20 has three diffraction regions 261, 263, and 264 which are separated from each other by a straight line 260a which is located extending through substantially a center of light L0 (the optical axis of the light collecting optical system) and is substantially parallel to the Y-axis (track direction), and a straight line 260b parallel to the X-axis (radial direction).

On the other hand, as shown in FIG. 8, a photodetector 40 has a photodetection region group 451, a photodetection region 452c, and a photodetection region 452d which are arranged side by side in the Y-direction. The photodetection region group 451 includes a photodetection region 451a and a photodetection region 451b which are provided, facing each other, on the opposite sides of a first dividing line 461 substantially parallel to the Y-axis.

The diffraction region 261 has a grating pattern similar to that described in the first embodiment. Specifically, the grating pattern of the diffraction region 261 diffracts returning light from an optical disk 10 toward the photodetection region group 451 so that the diffracted light straddles the opposite sides (the photodetection regions 451a and 451b) of the first dividing line 461. Moreover, the grating pattern diffracts the returning light to form a spot 601a having coma aberration in the Y-direction which enters the photodetection region group 451.

The diffraction region 263 has a straight-line grating pattern which diffracts returning light from the optical disk 10 to form a spot 603a on the photodetection region 452c.

The diffraction region 264 has a straight-line grating pattern which diffracts returning light from the optical disk 10 to form a spot 604a on the photodetection region 452d.

Here, because coma aberration is introduced to the light diffracted by the diffraction region 261 of the hologram element 20, the spot 601a has a certain spot diameter on the photodetector 40 even when focus is achieved. Therefore, even if the spot position is shifted due to a cause for error, such as wavelength shift, assembly tolerance, or the like, a sharp change in a photodetection signal can be reduced or prevented, whereby the offset of a focus servo signal can be reduced.

Next, in this embodiment, a focus error signal, a tracking error signal, and an RF signal are obtained by the following calculations:

FE=B−A (8)

TE_{DPD}=phase(B,D′)−phase(A,C′) (9)

TE_{PP}=(A+B)−(C′+D′) (10)

RF=A+B+C′+D′ (11)

where A, B, C′, and D′ each represent to a signal detected in the corresponding photodetection region of FIG. 8. Specifically, A represents a signal detected in the photodetection region 451b, B represents a signal detected in the photodetection region 451a, C′ represents a signal detected in the photodetection region 452c, and D′ represents a signal detected in the photodetection region 452d. The principle of operation of detecting a focus error signal is similar to that described in the first embodiment, and a focus error signal is generated only by the photodetection regions 451a and 451b of FIG. 4.

As can be seen from expressions (8), (9), and (10), the number of detection regions required to detect the FE signal, the DPD signal, and the PP signal, which are required to generate a servo signal for reproduction, is four, i.e., the photodetection regions 451a, 451b, 452c, and 452d. Thus, compared to six to eight detection regions required in the conventional art, a similar function can be achieved using a smaller number of detection regions. This can reduce the number of amplifier circuits required for the detection regions (by a half in some cases), whereby the amplifier noise and the circuit offset can be reduced, resulting in a satisfactory reproduced signal and servo signal. Moreover, the circuit size of an integrated circuit used in the optical head device can be reduced, whereby the optical head device can be achieved at a lower cost.

Moreover, in order to obtain a good-quality RF signal, it is necessary to arrange a semiconductor laser as a light source used in the optical head device so that the wide radiation angle direction of the semiconductor laser is parallel to the track direction of an information recording medium. In this regard, according to this embodiment, it is no longer necessary to provide holding means having a complicated configuration, such as an L-shaped configuration or the like, as means for holding the light source (the semiconductor laser 30) and the photodetector 40, i.e., a simple shape, such as that shown in FIG. 6, may be employed, whereby the optical head device can be achieved at an even lower cost.

Note that similar advantages can be obtained for disks of different standards, such as CDs, DVDs, and BDs, by changing the semiconductor laser as the light source.

### Third Embodiment

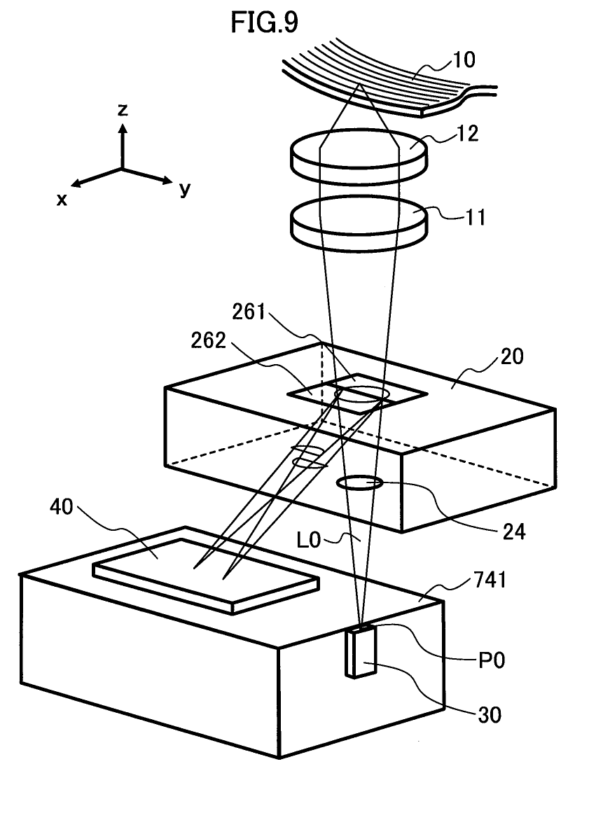

An optical head device according to a third embodiment of the present disclosure will be described hereinafter with reference to the drawings. FIG. 9 is a diagram schematically showing a main portion of the illustrative optical head device of this embodiment.

The illustrative optical head device of this embodiment detects a tracking error signal for recording and reproduction on an information recording medium, using the DPP method.

The illustrative optical head device of this embodiment has a basic configuration similar to that of the optical head device of the first embodiment of FIG. 1, except that the hologram element 20 further includes a diffraction grating 24. In FIG. 9, the same components as those of FIG. 1 are indicated by the same reference characters. Different portions will be mainly described hereinafter.

As shown in FIG. 9, light L0 emitted by a semiconductor laser 30 is diffracted at a desired ratio by the diffraction grating 24 of the hologram element 20 to be divided into a main beam (L0a) which is zeroth-order light, and sub-beams L0b and L0c which are ±first-order light (the beams are not individually shown). These beams are transmitted through diffraction regions 261 and 262 of the hologram element 20 before being collected onto an information recording surface of an optical disk 10 by a collimator lens 11 and an objective lens 12. Light reflected from the optical disk 10 is converted, by the objective lens 12 and the collimator lens 11, into light which is in turn converged toward an emission point P0 of the semiconductor laser 30. The light thus converted enters the hologram element 20 and is diffracted by the diffraction regions 261 and 262. The diffracted light enters the photodetector 40 and is detected as a signal. Here, a size and a position of the diffraction grating 24 are set so that the light diffracted by the diffraction regions 261 and 262 does not enter the diffraction grating 24 and is not further diffracted.

With the aforementioned configuration, a main beam and sub-beams can be generated from a light source, and can be used to obtain a focus error signal, and a tracking error signal which allows reproduction and recording, respectively.

Here, the diffraction regions 261 and 262 of the hologram element 20 have a configuration similar to that of FIG. 2.

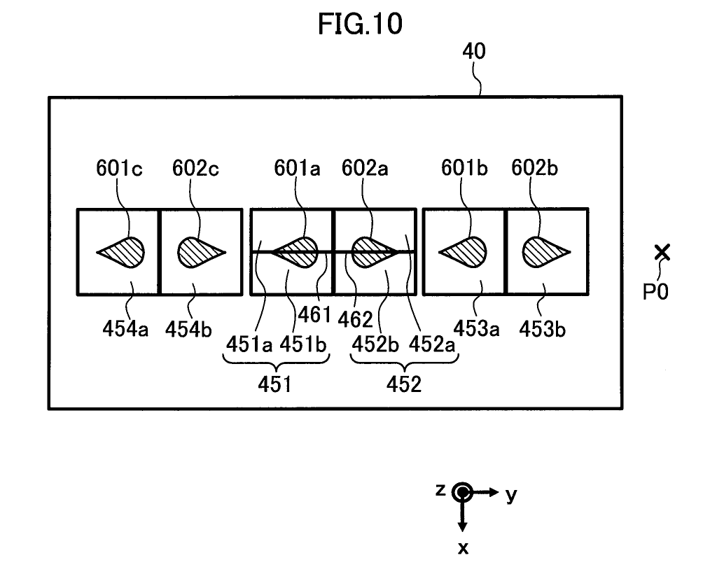

Next, a configuration of the photodetector 40 in this embodiment will be described. As shown in FIG. 10, the photodetector 40 has a photodetection region group 451 and a photodetection region group 452 which are arranged side by side in the Y-direction, and in addition, a photodetection region 453a and a photodetection region 453b, and a photodetection region 454a and a photodetection region 454b which are provided, facing each other, on the opposite sides in the Y-direction of the photodetection region groups 451 and 452.

Here, the main beam (L0a) of returning light from the optical disk 10 enters the photodetection region groups 451 and 452. In this case, because the grating patterns of the hologram element 20 introduce coma aberration, the spots 601a and 602a have a certain spot diameter on the photodetector 40 even when focus is achieved. Therefore, even if the spot position is shifted due to a cause for error, such as wavelength shift, assembly tolerance, or the like, a sharp change in a photodetection signal can be reduced or prevented, whereby the offset of a focus servo signal can be reduced.

Next, the photodetection regions 453a and 453b are arranged side by side in the Y-axis direction. Similarly, the photodetection regions 454a and 454b are arranged side by side in the Y-axis direction. The sub-beams (L0b and L0c) of the returning light from the optical disk 10 enter the photodetection regions 453a and 453b, and the photodetection regions 454a and 454b, respectively.

The sub-beam L0b is diffracted by the diffraction regions 261 and 262 of the hologram element 20. The light diffracted by the diffraction region 261 enters, as a spot 601b, the photodetection region 453a, while the light diffracted by the diffraction region 262 enters, as a spot 602b, the photodetection region 453b.

Similarly, the sub-beam L0c is diffracted by the diffraction regions 261 and 262 of the hologram element 20. The light diffracted by the diffraction region 261 enters, as a spot 601c, the photodetection region 454a, while the light diffracted by the diffraction region 262 enters, as a spot 602c, the photodetection region 454b.

Next, a method for detecting a focus error signal and a method for detecting a tracking error signal, based on light entering the photodetection regions, will be described. In the optical head device of this embodiment, a focus error signal FE, and a tracking error signal TE_{DPD} based on the DPD method, are calculated by the method described in the first embodiment using calculations of expressions (4) and (5), respectively. A tracking error signal TE_{DPP} based on the DPP method is generated by calculations of the following expressions (12), (13), and (14).

TE_{DPP}=TE_{MPP}−k×TE_{SPP} (12)

where TE_{MPP} represents a push-pull signal of the main beam, and TE_{SPP} represents a push-pull signal of the sub-beams, which are given by:

TE_{MPP}=(A+B)−(C+D) (13)

TE_{SPP}=E−F (14)

where A, B, C, D, E, and F each represent a signal detected in the corresponding photodetection region of FIG. 10. Specifically, A represents a signal detected in the photodetection region 451b, B represents a signal detected in the photodetection region 451a, C represents a signal detected in the photodetection region 452a, and D represents a signal detected in the photodetection region 452b. Also, E represents the sum of a signal detected in the photodetection region 453a and a signal detected in the photodetection region 454a, and F represents the sum of a signal detected in the photodetection region 453b and a signal detected in the photodetection region 454b. Also, k represents a constant which is optimized so that a variation in TE_{DPP} caused by shifting the objective lens 12 is minimized.

Also in this embodiment, the number of detection regions required to detect the FE signal, the DPD signal, and the MPP signal is four, i.e., the photodetection regions 451a, 451b, 452a, and 452b. Thus, compared to six to eight detection regions required in the conventional art, a similar function can be achieved using a smaller number of detection regions. Therefore, advantages similar to those described in the first embodiment can be obtained. Moreover, for the means for holding the light source and the photodetector, advantages similar to those described in the first embodiment (the holding means no longer needs to have an L shape or the like, and may have a simpler shape which can reduce a cost) can be obtained.

Moreover, the configuration of this embodiment is preferable in terms of the S/N ratio, because a focus servo signal is obtained based on diffracted light from all of the diffraction regions formed in the hologram element.

Moreover, TE_{SPP} for generating a tracking error signal can be generated only from the photodetection regions 453a and 453b, or only from the photodetection regions 454a and 454b. As described above, however, it is more preferable in terms of the S/N ratio that all of the photodetection regions 453a, 454a, 453b, and 454b are used.

Next, the applicability of the aforementioned focus error signal detecting method to optical information recording media having a plurality of information recording layers, will be described.

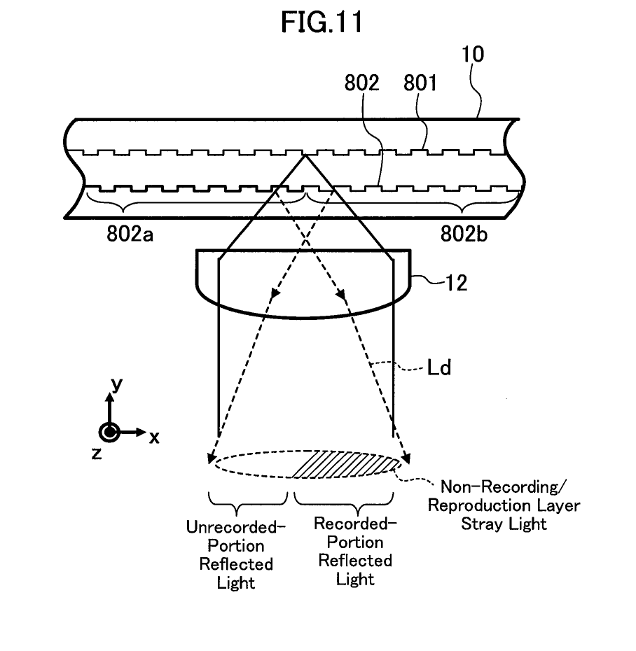

Firstly, a dual-layer optical information recording medium will be described. FIG. 11 schematically shows how information is recorded and reproduced to and from an optical disk 10 which is a dual-layer optical information recording medium having two information recording layers 801 and 802. Here, FIG. 11 shows a state in which light is focused on the information recording layer 801 which is located farther from the objective lens 12.

In this case, the incident light is reflected not only from the information recording layer 801, but also from the information recording layer 802 which is located closer to the objective lens 12. The light intensity distribution of the reflected light from the information recording layer 802 is modulated, depending a recording state of the information recording layer 802. Because the reflected light from the information recording layer 802 is light which is reflected in the out-of-focus state, the reflected light is not converted into parallel light even when the reflected light is transmitted through the objective lens 12. As a result, the reflected light enters, as diverging stray light, the photodetector 40. Note that the reflected light from the information recording layer 802 which is in such an out-of-focus state is shown as out-of-focus reflected light Ld using a dashed line in FIG. 11.

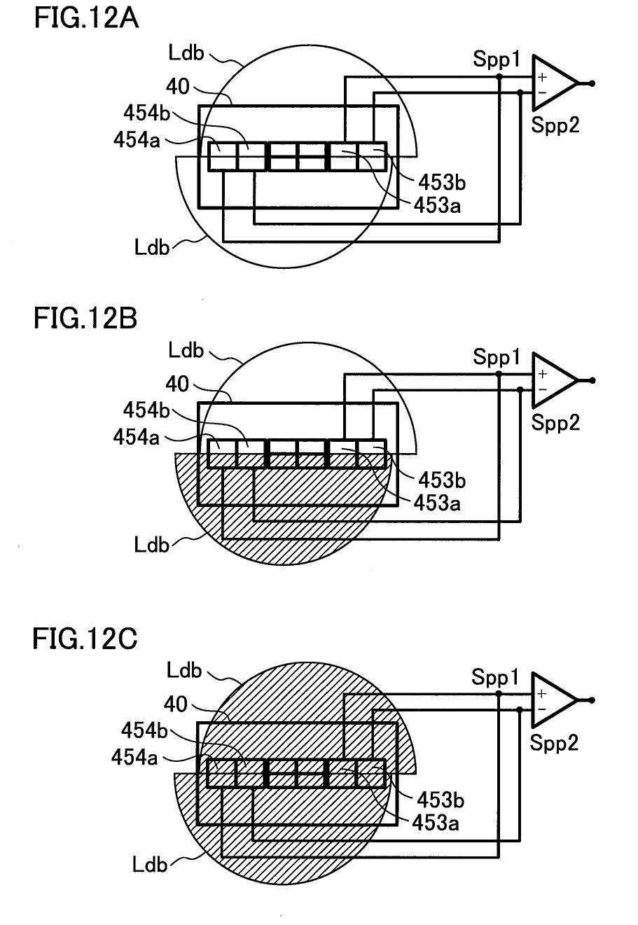

Next, FIGS. 12A-12C show states in which the out-of-focus reflected light Ld from the information recording layer 802 enters the photodetector 40. Here, FIG. 12A shows a case where all the out-of-focus reflected light Ld comes from an unrecorded area 802b of the information recording layer 802, FIG. 12B shows a case where the reflected light Ld comes from both a recorded area 802a and the unrecorded area 802b of the information recording layer 802, and FIG. 12C shows a case where all the reflected light Ld comes from the recorded area 802a of the information recording layer 802. Note that recorded area reflected light Lda from the recorded area 802a has a lower intensity than that of unrecorded area reflected light Ldb from the unrecorded area 802b. The unrecorded area reflected light Ldb corresponds to hatched portions of FIGS. 12A-12C.

Here, the variation of a tracking error signal is mainly caused by stray light derived from the main beam entering the photodetection regions 453a, 453b, 454a, and 454b. Therefore, the stray light derived from the main beam is shown in FIGS. 12A-12C, but stray light derived from the sub-beams (L0b and L0c) are not shown. The reflected light from the information recording layer 801 is also not shown.

The stray light derived from the main beam extends off a photodetection region which generates TE_{MPP} (the photodetection region groups 451 and 452), and also enters a photodetection region which generates TE_{SPP} (the photodetection regions 453a, 453b, 454a, and 454b).

The amplification gain of a signal detected from the photodetection region which generates TE_{SPP} (the photodetection regions 453a, 453b, 454a, and 454b) is typically set to be larger than the amplification gain of a signal detected from the photodetection region which generates TE_{MPP} (the photodetection region groups 451 and 452). Therefore, conventionally, the stray light derived from the main beam has a significant influence on TE_{SPP}.

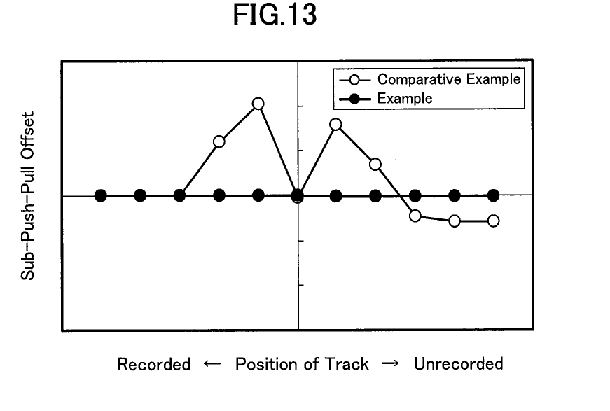

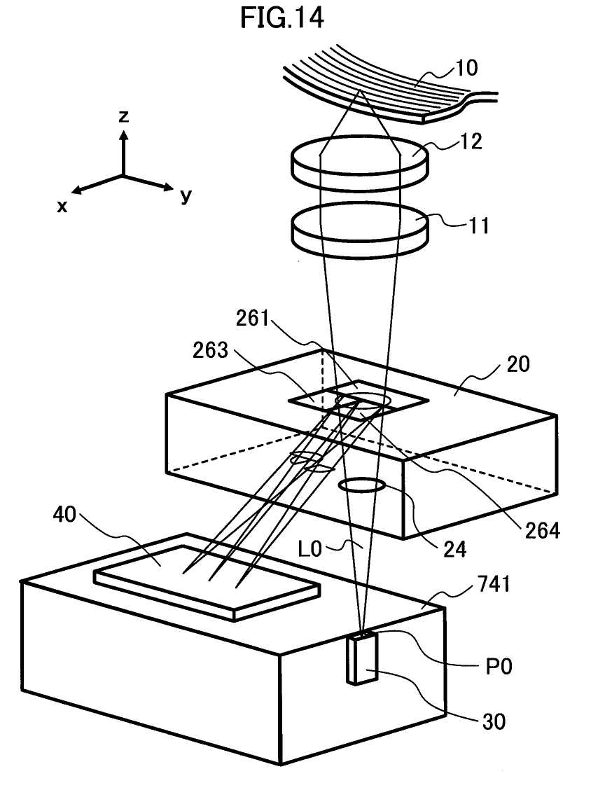

In this regard, FIG. 13 shows offsets of TE_{SPP} signals as they are when an out-of-focus spot moves across the boundary between a recorded area and an unrecorded area on the information recording layer 802. Here, FIG. 13 shows a comparative example (the example described in the BACKGROUND section), and an example of the present disclosure (this embodiment). As shown in FIG. 13, while, in the comparative example, the TE_{SPP} signal varies when the spot moves across the boundary between a recorded area and an unrecorded area of an information recording medium, in this embodiment a stable tracking error signal which substantially does not vary is generated.

This is because, in this embodiment, even when out-of-focus light straddles the boundary between a recorded area and an unrecorded area, the variation of the TE_{SPP} signal is canceled in the photodetection regions 453a and 453b which generates the TE_{SPP} signal, and in the photodetection regions 454a and 454b which generates the TE_{SPP} signal.

Specifically, the photodetection regions 453a and 453b are arranged side by side in the Y-axis direction. As a result, even when the recorded area reflected light Lda having a decreased intensity which is reflected light from the recorded area 802a enters the photodetection regions 453a and 453b, variations in signals in the photodetection regions 453a and 453b are substantially equal to each other. Therefore, the TE_{SPP} signal which is a difference between these signals does not vary.

Similarly, the photodetection regions 454a and 454b are arranged side by side in the Y-axis direction. Therefore, even when the recorded area reflected light Lda having a decreased intensity which is reflected light from the recorded area 802a enters the photodetection regions 454a and 454b, variations in signals in the photodetection regions 454a and 454b are substantially equal to each other. Therefore, the TE_{SPP} signal which is a difference between these signals does not vary.

As a result, even when an out-of-focus spot moves across the boundary between the recorded area 802a and the unrecorded area 802b of the information recording layer 802, a variation in the TE_{SPP} signal does not occur, and therefore, a tracking error signal can be stably detected.

Note that it has been assumed above that a recording medium has a lower reflectance in a recorded area than in an unrecorded area. Conversely, a recording medium may have a higher reflectance in a recorded area than in an unrecorded area. In this case, in FIGS. 12A-12C, the hatched portions may be assumed to indicate regions having a higher light intensity.

### Fourth Embodiment

In the third embodiment, a configuration has been described in which two diffraction regions of a hologram element both have a pattern for introducing coma aberration. Alternatively, only one of the diffraction regions may have a pattern for introducing coma aberration. The offset of a focus servo signal due to a cause for error, such as wavelength shift, assembly tolerance, or the like, which occurs in the configuration of FIG. 18 described in the BACKGROUND section, can be reduced by the following embodiment in which coma aberration is introduced to diffracted light of one of the hologram patterns.

An illustrative optical head device according to a fourth embodiment of the present disclosure which has a configuration in which a pattern for introducing coma aberration is formed only in one of two diffraction regions of a hologram element, will be described hereinafter with reference to the drawings. FIG. 14 schematically shows a main portion of the optical head device of this embodiment.

The optical head device of FIG. 14 has a basic configuration similar to that of the optical head device of the third embodiment of FIG. 9, except that the diffraction region of a hologram element 20 is divided into three. In FIG. 14, the same components as those of FIG. 9 are indicated by the same reference characters. Different portions will be mainly described hereinafter.

Also in this configuration, a main beam and sub-beams can be generated from a light source by the diffraction grating 24, and the main beam can be used to obtain a focus error signal, and the sub-beams can be used to obtain a tracking error signal which allows reproduction and recording. Note that the hologram element 20 has a configuration similar to that of FIG. 7.

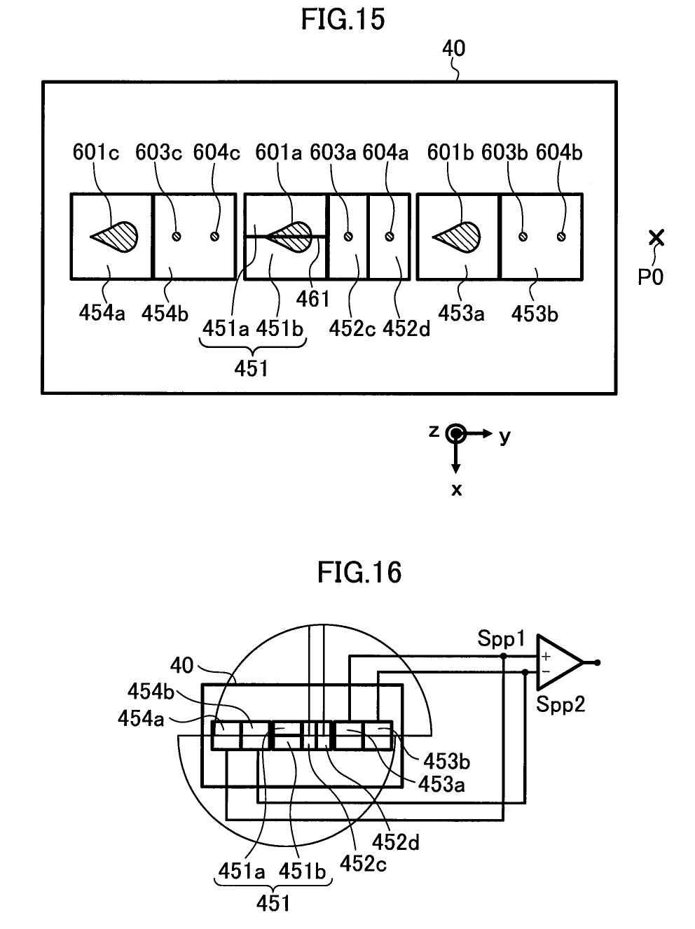

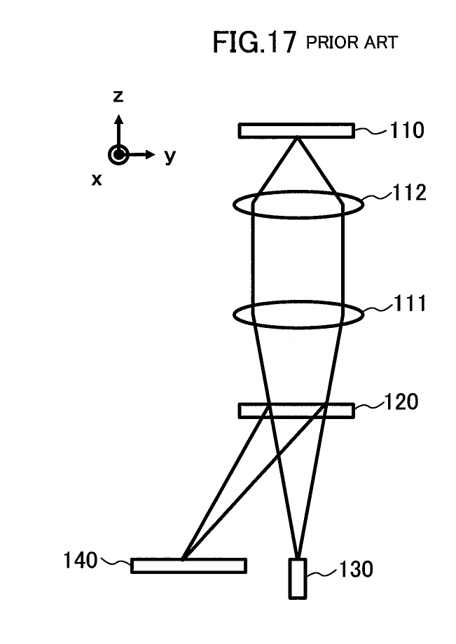

Next, a configuration of a photodetector 40 in this embodiment will be described. The photodetector 40 has a configuration shown in FIG. 15. The photodetector 40 has a photodetection region group 451, a photodetection region 452c, and a photodetection region 452d which are arranged side by side in the Y-direction as is similar to that shown in FIG. 8, and in addition, a photodetection region 453a and a photodetection region 453b, and a photodetection region 454a and a photodetection region 454b which are provided, facing each other, on the opposite sides in the Y-direction of the photodetection region group 451 and the photodetection regions 452c and 452d.

A main beam (L0a) of returning light from an optical disk 10 enters the photodetection region group 451 and the photodetection regions 452c and 452d.

Here, because the grating patterns of the hologram element 20 introduce coma aberration, a spot 601a has a certain spot diameter on the photodetector 40 even when focus is achieved. Therefore, even if the spot position is shifted due to a cause for error, such as wavelength shift, assembly tolerance, or the like, a sharp change in a photodetection signal can be reduced or prevented, whereby the offset of a focus servo signal can be reduced.

Next, the photodetection regions 453a and 453b are arranged side by side in the Y-axis direction. Similarly, the photodetection regions 454a and 454b are arranged side by side in the Y-axis direction. Sub-beams (L0b and L0c) of the returning light from the optical disk 10 enter the photodetection regions 453a and 453b, and the photodetection regions 454a and 454b, respectively.

The sub-beam L0b is diffracted by diffraction regions 261, 263, and 264 of the hologram element 20. The light diffracted by the diffraction region 261 enters, as a spot 601b, the photodetection region 453a. The light diffracted by the diffraction region 263 enters, as a spot 603b, the photodetection region 453b. The light diffracted by the diffraction region 264 enters, as a spot 604b, the photodetection region 453b.

Similarly, the sub-beam L0c is diffracted by the diffraction regions 261, 263, and 264 of the hologram element 20. The light diffracted by the diffraction region 261 enters, as a spot 601c, the photodetection region 454a. The light diffracted by the diffraction region 263 enters, as a spot 603c, the photodetection region 454b. The light diffracted by the diffraction region 264 enters, as a spot 604c, the photodetection region 454b.

Next, a method for detecting a focus error signal and a method for detecting a tracking error signal, based on light entering the photodetection regions, will be described.

In the optical head device of this embodiment, a focus error signal FE, and a tracking error signal TE_{DPD} based on the DPD method, are obtained by the method described in the second embodiment using calculations of expressions (8) and (9), respectively. A tracking error signal TE_{DPP} based on the DPP method is generated by calculations of expressions (12) and (14), and the following expression (15).

TE_{MPP}=(A+B)−(C′+D′) (15)

where A represents a signal detected in the photodetection region 451b, B represents a signal detected in the photodetection region 451a, C′ represents a signal detected in the photodetection region 452c, and D′ represents a signal detected in the photodetection region 452d.

Note that TE_{SPP} for generating a tracking error signal can be generated only from the photodetection regions 453a and 453b, or only from the photodetection regions 454a and 454b. As described above, however, it is more preferable in terms of the S/N ratio that all of the photodetection regions 453a, 454a, 453b, and 454b are used.

Also in this embodiment, the number of detection regions required to detect the FE signal, the DPD signal, and the MPP signal is four, i.e., the photodetection regions 451a, 451b, 452c, and 452d. Thus, compared to six to eight detection regions required in the conventional art, a similar function can be achieved using a smaller number of detection regions. Therefore, advantages similar to those described in the first embodiment can be obtained. Moreover, for the means for holding the light source and the photodetector, advantages similar to those described in the first embodiment (the holding means no longer needs to have an L shape or the like, and may have a simpler shape which can reduce a cost) can be obtained.

Also in this embodiment, the aforementioned focus error signal detecting method is applicable to optical information recording media having a plurality of information recording layers. This will be described hereinafter.

FIG. 16 shows a state in which out-of-focus reflected light Ld which is the main beam reflected from an information recording layer 802 enters the photodetector 40. Out-of-focus reflected light beams which are the main beam reflected from the diffraction regions 263 and 264 of the hologram element 20 as well as out-of-focus reflected light which is the main beam diffracted by the diffraction region 261, enter and overlap the photodetection regions 453a, 453b, 454a, and 454b which receive the sub-beams.

The photodetection regions 453a, 453b, 454a, and 454b which receive the sub-beams are arranged in a manner similar to that of the third embodiment (see FIG. 10). Therefore, for a reason similar to that described in the third embodiment, even when a variation in the amount of light due to a recorded area and an unrecorded area occurs in out-of-focus reflected light, a stable tracking error signal can be obtained.

According to the aforementioned optical head device, optical information processing apparatus, and focus error signal detecting method, a higher-quality servo signal can be obtained at a lower cost, and therefore, reproduction or recording can be more stably performed. The optical head device, the optical information processing apparatus, and the focus error signal detecting method of the present disclosure are applicable to information reproduction and recording using optical information recording media, particularly to applications, such as storage of data or programs in computers, storage of map data in automotive navigation systems, and the like.

What is claimed is:

1. An optical head device comprising:
a light source configured to emit a light beam;
a light collecting optical system configured to converge the light beam onto an information recording medium;
a hologram element configured to diffract the light beam reflected from the information recording medium; and
a photodetector having a plurality of detection regions configured to receive the light beam diffracted by the hologram element,
wherein
the hologram element has a plurality of diffraction regions separated from each other by a straight line extending in a track direction of the information recording medium, and
at least one of the plurality of diffraction regions has a pattern which introduces coma aberration in the track direction to the diffracted light.

2. The optical head device of claim 1, wherein
at least one pair of detection regions of the plurality of detection regions possessed by the photodetector are provided, facing each other, on opposite sides of the dividing line extending in the track direction,
the diffracted light having the coma aberration is incident on the dividing line, and
a focus error signal is obtained based on signals detected in the at least one pair of detection regions.

3. The optical head device of claim 2, wherein
the plurality of diffraction regions includes, in addition to the at least one diffraction region having the pattern which introduces the coma aberration, a pair of diffraction regions separated from each other by a straight line extending in a radial direction of the information recording medium,
the plurality of detection regions possessed by the photodetector include a second pair of detection regions provided, facing each other, on opposite sides of a second dividing line extending in the radial direction,
light beams diffracted by the pair of diffraction regions enter the second pair of detection regions, respectively, and
a tracking error signal is obtained based on signals detected in the at least one pair of detection regions and the second pair of detection regions.

4. An optical head device comprising:
a light source configured to emit a light beam;
a light collecting optical system configured to converge the light beam onto an information recording medium;
a hologram element configured to diffract the light beam reflected from the information recording medium; and
a photodetector having a plurality of detection regions configured to receive the light beam diffracted by the hologram element,
wherein
the plurality of detection regions possessed by the photodetector include a first photodetection region and a second photodetection region provided, facing each other, on opposite sides of a first dividing line extending in a track direction of the information recording medium, and a third photodetection region and a fourth photodetection region provided, facing each other, on opposite sides of a second dividing line extending in the track direction,
the hologram element has a first diffraction region and a second diffraction region separated from each other by a straight line extending in the track direction,
the first diffraction region has a pattern which introduces coma aberration in the track direction, and generates diffracted light converging onto the first dividing line,
the second diffraction region has a pattern which introduces coma aberration in the track direction, and generates diffracted light converging onto the second dividing line, and
a focus error signal is obtained based on a differential signal between a signal in the first detection region and a signal in the second detection region, and a differential signal between a signal in the third detection region and a signal in the fourth detection region.

5. An optical head device comprising:
a light source configured to emit a light beam;
a diffraction grating configured to generate one main beam and two sub-beams from the light beam;
a light collecting optical system configured to converge the main beam and the sub-beams onto an information recording medium;
a hologram element configured to diffract the main beam and the sub-beams reflected from the information recording medium; and
a photodetector having a plurality of detection regions configured to receive light diffracted by the hologram element,
wherein
the hologram element has a plurality of diffraction regions separated from each other by a straight line extending in a track direction of the information recording medium, and
at least one of the plurality of diffraction regions has a pattern which introduces coma aberration in the track direction to the diffracted light.

6. The optical head device of claim 5, wherein
the plurality of detection regions possessed by the photodetector include a first pair of detection regions provided, facing each other, on opposite sides of a first dividing line extending in the track direction, and a second detection region and a third detection region provided in the track direction of the information recording medium relative to the first pair of detection regions,
the diffracted light of the main beam having the coma aberration is incident on the first dividing line of the first pair of detection regions,
a focus error signal is obtained based on signals detected in the first pair of detection regions,
the diffracted light of the sub-beams enters the second and third detection regions, and
a tracking error signal is obtained based on signals detected in the second and third detection regions.

7. An optical information processing apparatus comprising:
the optical head device of claim 1,
wherein
information is recorded and reproduced to and from the information recording medium by irradiating the information recording medium with light.

8. An optical information processing apparatus comprising:
the optical head device of claim 4,
wherein
information is recorded and reproduced to and from the information recording medium by irradiating the information recording medium with light.

9. An optical information processing apparatus comprising:
the optical head device of claim 5,
wherein
information is recorded and reproduced to and from the information recording medium by irradiating the information recording medium with light.

10. A method for detecting a focus error signal for an optical head device, wherein
the optical head device includes
a light source configured to emit a light beam,
a light collecting optical system configured to converge the light beam onto an information recording medium,
a hologram element configured to diffract the light beam reflected from the information recording medium, and
a photodetector having a plurality of detection regions configured to receive the light beam diffracted by the hologram element,
the hologram element has a plurality of diffraction regions separated from each other by a straight line extending in a track direction of the information recording medium,
at least one of the plurality of diffraction regions has a pattern which introduces coma aberration in the track direction to the diffracted light,
at least one pair of detection regions of the plurality of detection regions possessed by the photodetector are provided, facing each other, on opposite sides of a dividing line extending in the track direction,
the diffracted light having the coma aberration is incident on the dividing line, and
the method comprises the step of
obtaining the focus error signal based on signals detected in the at least one pair of detection regions.

11. A method for detecting a focus error signal for an optical head device, wherein
the optical head device includes
a light source configured to emit a light beam,
a light collecting optical system configured to converge the light beam onto an information recording medium,
a hologram element configured to diffract the light beam reflected from the information recording medium, and
a photodetector having a plurality of detection regions configured to receive the light beam diffracted by the hologram element,
the plurality of detection regions possessed by the photodetector include a first photodetection region and a second photodetection region provided, facing each other, on opposite sides of a first dividing line extending in a track direction of the information recording medium, and a third photodetection region and a fourth photodetection region provided, facing each other, on opposite sides of a second dividing line extending in the track direction,
the hologram element has a first diffraction region and a second diffraction region separated from each other by a straight line extending in the track direction,
the first diffraction region has a pattern which introduces coma aberration in the track direction, and generates diffracted light converging onto the first dividing line,
the second diffraction region has a pattern which introduces coma aberration in the track direction, and generates diffracted light converging onto the second dividing line, and
the method comprises the step of:
obtaining a focus error signal based on a differential signal between a signal in the first detection region and a signal in the second detection region, and a differential signal between a signal in the third detection region and a signal in the fourth detection region.
